(19) United States
(12) Patent Application Publication
(10) Pub. No.: US 2009/0047991 A1
(43) Pub. Date: Feb. 19, 2009

(54) AUTOMATICALLY ENABLING AND DISABLING WIRELESS NETWORKS

(75) Inventor: Johannes ELG, Helsingborg (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/837,574

(22) Filed: Aug. 13, 2007

(51) Int. Cl. H04M 1/00

(52) U.S. Cl. 455/552.1

(57) ABSTRACT

A portable electronic device includes a first wireless interface based on a first wireless technology, said first wireless interface operative to establish a two-way wireless communication link, a second wireless interface based on a second wireless technology different from the first wireless technology, said second wireless interface operative to establish a two-way wireless communication link, and a discovery circuit operatively coupled to the first wireless interface and the second wireless interface. The discovery circuit is operative to use the first wireless interface to identify wireless capabilities of at least one other device, and to enable or disable the second wireless interface based on the detected capabilities of the at least one other device.

### TECHNICAL FIELD OF THE INVENTION

The present invention relates generally to electronic devices, such as electronic devices for engaging in voice communications. More particularly, the invention relates to a device and method for automatically detecting wireless-enabled devices using a primary wireless interface, and enabling or disabling secondary wireless interfaces based on data collected by the primary wireless interface.

### DESCRIPTION OF THE RELATED ART

Mobile and/or wireless items of electronic devices are becoming increasingly popular and are now in wide-spread use. In addition, the features associated with certain types of electronic devices have become increasingly diverse. To name a few examples, many electronic devices include cameras, text messaging capability, Internet browsing functionality, electronic mail capability, video playback capability, audio playback capability, image display capability, navigation capability, and hands-free headset interfaces.

Many of the above features utilize a wireless interface to exchange data between the electronic device and other electronic devices, computers, servers, etc. As will be appreciated, it is desirable to utilize wireless interfaces that employ technologies offering high-speed data transfer rates and/or long range connectivity. This reduces the time required to transfer data to/from the electronic device and/or increases the maximum allowable distance between devices, which can make the overall wireless experience more enjoyable for the user.

New wireless technologies continue to be developed and offered on electronic devices. Examples of such wireless technologies include: WiFi (i.e., wireless communications based on the 802.11x standard); WiMedia; W-USB, WLP, W1394 and other wireless communications based on the ECMA-368 standard; etc. These wireless technologies offer advantages, including very high speed connectivity, enhanced security and/or increased range, which may not found in older wireless technologies. As a result, such wireless technologies are desirable in electronic equipment.

### SUMMARY

A drawback of many wireless communication interfaces that use long-range, high-speed wireless technologies is that they tend to consume more power than communication interfaces based on conventional, short-range, low-speed wireless technologies. This is true not only when a communication link is actually established, but also when a search is performed for other devices (e.g., scanning for other devices that utilize a radio transceiver based on the same wireless technology).

Since electronic devices typically are battery powered, it is desirable to minimize the power consumption of the electronic device, thereby increasing battery life. One way this may be accomplished is to disable at least one unused wireless interface of the electronic device. If disabled, however, then without user intervention, the electronic device cannot use the disabled wireless interface to detect and/or communicate with other devices that utilize the same wireless technology. This is not desirable.

The present invention provides a device and method that enables one or more secondary wireless interfaces of an electronic device to be in an “off” or disabled state when not in use, thereby conserving power. Moreover, the disabled secondary wireless interface(s) can be automatically placed in an “on” or enabled state when another device capable of communicating over the secondary wireless interface is present. Detection of the other devices can be via a primary interface that preferably uses low-power wireless technology, such as, for example, Bluetooth®. Wireless interfaces based on other technologies also may be employed.

Using the primary wireless interface, the electronic device can obtain information regarding the capabilities of the other device. Based on this information, the disabled secondary wireless interfaces may be enabled and, using the newly enabled secondary interface, a communication link may be established between the electronic device and the other device.

According to one aspect of the invention, a portable electronic device includes: a first wireless interface based on a first wireless technology, said first wireless interface operative to establish a two-way wireless communication link; a second wireless interface based on a second wireless technology different from the first wireless technology, said second wireless interface operative to establish a two-way wireless communication link; and a discovery circuit operatively coupled to the first wireless interface and the second wireless interface, said discovery circuit operative to use the first wireless interface to identify wireless capabilities of at least one other device, and to enable or disable the second wireless interface based on the detected capabilities of the at least one other device.

According to one aspect of the invention, in at least one of a standby mode or an active mode, the second wireless interface consumes more power than the first wireless interface.

According to one aspect of the invention, the first wireless interface is operative to exchange data at a first data rate, and the second wireless interface is operative to exchange data at a second data rate, wherein the second data rate is greater than the first data rate.

According to one aspect of the invention, the first wireless interface is a Bluetooth interface.

According to one aspect of the invention, the discovery circuit is operative to use a service discovery protocol (SDP) and universally unique identifier (UUID) to identify the wireless capabilities of the device.

According to one aspect of the invention, the discovery circuit is operative to use an extended inquiry response (EIR) to identify additional information of the at least one other device.

According to one aspect of the invention, the second wireless interface is based on at least one of the 802.11x standard or the ECMA-368 standard.

According to one aspect of the invention, the discovery circuit is further operative to send a command to the at least one other device via the first interface, said command instructing the at least one other device to enable an interface of the at least one other device corresponding to the second wireless interface.

According to one aspect of the invention, the portable electronic device is a mobile telephone.

According to one aspect of the invention, the portable electronic device is at least one of a communicator, electronic organizer, personal digital assistant, smart phone, portable communication apparatus, portable gaming device, or portable media devices.

According to one aspect of the invention, there is provided a method for conserving power in a portable electronic device, said portable electronic device including a first wireless interface and a second wireless interface different from the first wireless interface, the method including: using the first wireless interface to establish a communication link with at least one other wireless device; via the first wireless interface, obtaining from the at least one other wireless device data corresponding to wireless capabilities of the at least one other wireless device; enabling or disabling the second wireless interface based on the obtained data.

According to one aspect of the invention, enabling or disabling includes turning a transceiver of the second wireless interface on or off.

According to one aspect of the invention, using the first wireless interface to establish the communication link includes using the first wireless interface to scan for the at least one other wireless device prior to establishing the communication link.

According to one aspect of the invention, using the first wireless interface includes using a Bluetooth wireless interface as the first wireless interface.

According to one aspect of the invention, the method further comprises using a service discovery protocol (SDP) and universally unique identifier (UUID) to identify the wireless capabilities of the at least one other wireless device.

According to one aspect of the invention, the method further comprises using an extended inquiry response (EIR) to identify additional information of the at least one other wireless device.

According to one aspect of the invention, obtaining from the at least one other wireless device data corresponding to wireless capabilities of the at least one other wireless device includes at least one of searching or browsing the capabilities of the at least one other wireless device.

According to one aspect of the invention, the second wireless interface is based on at least one of the 802.11x standard or the ECMA-368 standard.

According to one aspect of the invention, the second wireless interface is at least one of WLAN, W-USB or WiMedia Logical Link Control Protocol (WLP).

According to one aspect of the invention, the method further comprises sending a command from the portable electronic device to the at least one other device, said command instructing the at least one other device to enable at least one interface of the device, said at least one interface corresponding to the second wireless interface.

According to one aspect of the invention, there is provided a computer program embodied on a machine readable medium for conserving power in a portable electronic device, said portable electronic device including a first wireless interface and a second wireless interface different from the first wireless interface, the program comprising: code that uses the first wireless interface to establish a communication link with at least one other wireless device; code that via the first wireless interface obtains from the at least one other wireless device data corresponding to wireless capabilities of the at least one other wireless device; and code that enables or disables the second wireless interface based on the obtained data.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic view of a mobile telephone as an exemplary electronic device in accordance with an embodiment of the present invention.

FIG. 2 is a schematic block diagram of the relevant portions of the mobile telephone of FIG. 1 in accordance with an embodiment of the present invention.

FIG. 3 is a schematic diagram of a communications system in which the mobile telephone of FIG. 1 may operate.

FIGS. 4A and 4B illustrate an exemplary detection of devices using a primary wireless interface, and then enabling one or more secondary wireless interfaces in accordance with the invention.

FIG. 5 is a block diagram of service discovery protocol that may be used in conjunction with the invention.

FIG. 6 is a flow chart of an exemplary discovery function in accordance with the invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smart phones, portable communication apparatus, portable gaming devices, portable media devices (video and/or audio), and the like.

In the present application, embodiments of the invention are described primarily in the context of a mobile telephone. However, it will be appreciated that the invention is not intended to be limited to the context of a mobile telephone and may relate to any type of appropriate electronic equipment.

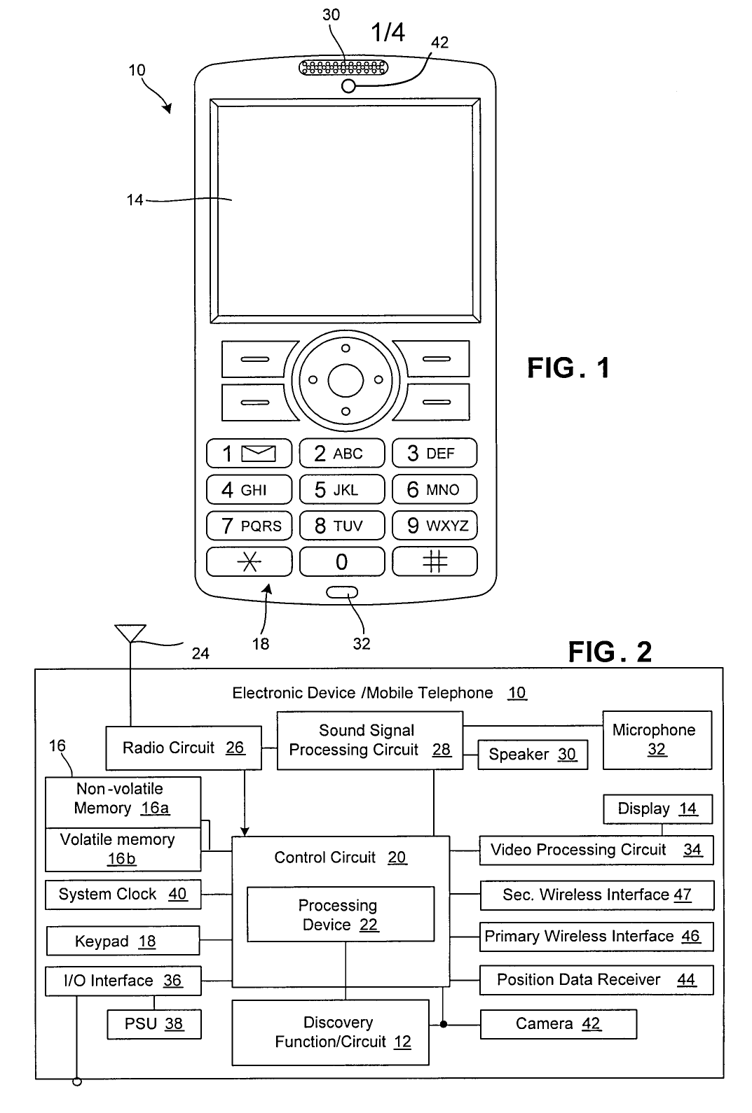

Referring initially to FIGS. 1 and 2, an electronic device 10 is shown. The electronic device 10 includes a discovery function 12 that is configured to use a primary interface (preferably a low-power wireless interface based on the Bluetooth standard or other low power standard) to detect the presence of other wireless devices, determine their communication abilities, and to enable and/or disable wireless interfaces within the electronic device based on the communication abilities of the detected devices. Additional details and operation of the discovery function 12 will be described in greater detail below. The discovery function 12 may be embodied as executable code that is resident in and executed by the electronic device 10. In one embodiment, the discovery function 12 may be a program stored on a computer or machine readable medium. The discovery function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a brick or block form factor, although other form factors, such as a “flip-open” form factor (e.g., a “clamshell” housing) or a slide-type form factor (e.g., a “slider” housing) also my be utilized.

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for short message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein.

The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10.

The memory 16 may include a read only memory area that is implemented using nonvolatile memory 16a, and a random access or system memory area that is implemented using volatile memory 16b. As will be appreciated, nonvolatile memory tends not to lose data storage capability upon loss of power and is typically used to store data, application code, files and so forth. The nonvolatile memory 16a may be implemented with a flash memory, for example. The flash memory may have a NAND architecture, but other flash memory architectures, such as a NOR architecture, may be used. As will be appreciated, volatile memory tends to lose data storage capability upon loss of power and is typically used to store data for access by the processing device 22 during the execution of logical routines. The volatile memory 16b may be a random access memory (RAM). The RAM may be a synchronous dynamic random access memory (SDRAM), for example, but other RAM architectures that utilize memory blocks may be used. Data may be exchanged between the nonvolatile memory 16a and the volatile memory 16b as is conventional. The nonvolatile memory 16a and the volatile memory 16b may be sized as is appropriate for the mobile telephone 10 or other electronic device in which the memory 16 is used.

In addition, the processing device 22 may execute code that implements the discovery function 12. It will be apparent to a person having ordinary skill in the art of computer programming, and specifically in application programming for mobile telephones or other electronic devices, how to program a mobile telephone 10 to operate and carry out logical functions associated with the discovery function 12 based on the description herein. Accordingly, details as to specific programming code have been left out for the sake of brevity. Also, while the discovery function 12 is executed by the processing device 22 in accordance with a preferred embodiment of the invention, such functionality could also be carried out via dedicated hardware, firmware, software, or combinations thereof, without departing from the scope of the invention. Any of these implementations may be referred to as a discovery circuit 12 or simply a logic circuit.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 42 for taking digital pictures, movies and/or conducting video phone calls. As will be appreciated, the location of the camera on the mobile telephone may be dependent on the type of camera (e.g., a video phone camera may be on the front side of the phone, while a snapshot camera may be on the backside of the phone). Image and/or video files corresponding to the pictures and/or movies may be stored in the memory 16.

The mobile telephone 10 also may include a position data receiver 44, such as a global positioning system (GPS) receiver, Galileo satellite system receiver or the like.

The mobile telephone 10 also includes a local wireless interface 46, such as an infrared transceiver and/or an RF interface (e.g., a Bluetooth interface or the like), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface. Preferably, the local wireless interface 46 consumes relatively low power (e.g., power levels less than or on the same order as that utilized by Bluetooth enabled devices) while in the standby mode (e.g., while scanning for other devices), and more preferably also consumes relatively low power also while in the active mode (e.g., while communicating with other devices).

In addition to the local wireless interface, the mobile telephone 10 also includes one or more secondary wireless interfaces 47, such as a WiFi interface (also referred to as WLAN or wireless local area network), UWB, WiNET, W-USB (wireless universal serial bus), WLP (or other ECMA-368 based standard), etc. The secondary wireless interface 47 enables the mobile telephone 10 to communicate with other electronic devices, computers, media players, etc. that utilize the same type of interface. Preferably, the secondary wireless interface 47 offers higher speed connectivity, enhanced security, and greater range than that of the local wireless interface 46. Typically, the enhanced features of the secondary wireless interface 47 come at the expense of increased power consumption relative to the local wireless interface 46.

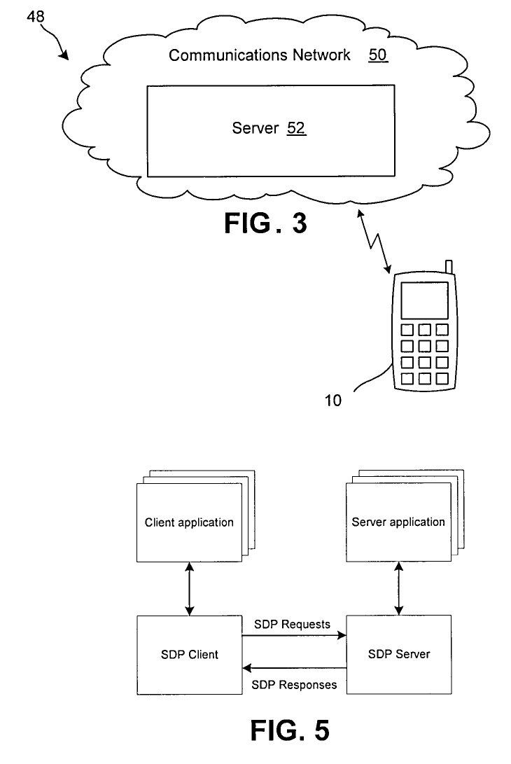

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices.

As will be appreciated, the server 52 may be configured as a typical computer system used to carry out server functions and may include a processor configured to execute software containing logical instructions that embody the functions of the server 52 and a memory to store such software.

Moving now to the discovery function/circuit 12, this feature is operative to automatically enable and disable certain wireless interfaces of the mobile telephone 10, thereby reducing power consumption. As described in more detail below, the discovery function/circuit 12 maintains one wireless interface (e.g., the primary wireless interface 46) in an enabled state, wherein the primary wireless interface 46 operates using a first protocol. In the enabled state, the primary wireless interface may scan for other devices that are capable of wireless communications using the first protocol. Further, the discovery function/circuit 12 maintains one or more secondary interfaces 47 in a disabled state. In the disabled state, the secondary interfaces 47 cannot scan for other devices, nor can they be detected by the other devices.

The discovery function/circuit 12 may direct the primary interface 46 to continuously or periodically scan for other devices in the area. If the primary interface 46 detects other devices, then a communication link is established via the primary interface 46, and the discovery function/circuit 12 communicates over the primary interface 46 with the other device(s) (e.g., between the mobile telephone 10 and a computer, another mobile telephone, media player, etc.). The discovery function/circuit 12 then requests that the other device provide information regarding the communication capabilities of the other device. The other device then can respond to the request and provide such information via the primary interface 46. Based on the capabilities of the mobile telephone 10 and the other device(s), the discovery function/circuit 12 may enable one or more of the secondary interfaces 47 of the mobile telephone 10 and/or of the other device(s), and these enabled interfaces can be used to establish a communication link. An example is provided below, wherein the primary interface utilizes the Bluetooth standard.

As previously noted, the mobile telephone 10 may include multiple wireless interfaces, such as the local or “primary” wireless interface 46 and the secondary wireless interface 47. In the exemplary embodiment, the primary wireless interface is based on the Bluetooth standard. However, the primary wireless interface 46 may be based on other wireless standards, and reference to the Bluetooth standard is not intended to be limiting in any way. For example, the primary wireless interface may be based on other radio standards, including protocols other than Bluetooth, as well as RFID, or optical communication standards (e.g., wireless infrared communication).

Preferably, the primary wireless interface 46 is a low power interface that consumes no more power than the secondary wireless interface 47. More preferably, the primary wireless interface 46 consumes less power than the secondary wireless interface 47. Regardless of the relative power consumption of the primary and secondary interfaces, the discovery function/circuit 12 can conserve power by maintaining the secondary wireless interfaces 47 in a disabled state until compatible interfaces are detected via the primary wireless interface 46.

The secondary wireless interface 47 also may utilize any wireless standard, non-limiting examples of which include WiFi (802.11x), WiMAX, WiMedia, W-USB (ECMA-368), infrared, etc. Further, although only a single secondary wireless interface 47 is shown in FIG. 2, the mobile telephone 10 may have multiple secondary interfaces.

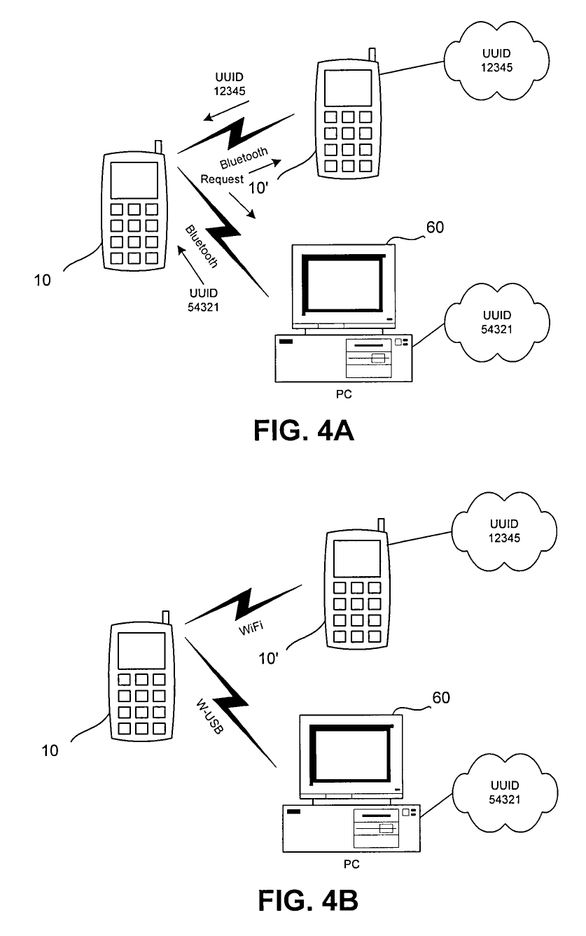

With further reference to FIGS. 4A and 4B, there is shown an exemplary implementation of the discovery function/circuit 12 in the mobile telephone 10. In FIG. 4A, the mobile telephone 10 has a Bluetooth interface as well as WiFi and W-USB interfaces. Initially, the WiFi and W-USB interfaces of the mobile telephone 10 are disabled. A second mobile telephone 10′ also has a Bluetooth interface and a WiFi interface, while a computer 60 has a Bluetooth interface and a W-USB interface. The WiFI and W-USB interfaces of the phone 10′ and computer 60 may be enabled or disabled.

The discovery function/circuit 12 of the mobile phone 10 uses the Bluetooth interface to scan the area for other devices that are Bluetooth enabled. If the mobile telephone 10′ and/or the computer 60 are within range of the mobile telephone 10, then a communication link is established between the respective devices using the Bluetooth interface (e.g., between the phone 10 and the computer 60, and/or between the phone 10 and the phone 10′). Once a communication link is established, the discovery function/circuit 12 requests the communication capabilities of the respective devices. The mobile telephone 10′ and/or computer 60 then provide such information to the mobile telephone 10 via the Bluetooth interface.

The discovery function/circuit 12 then analyzes the data to determine if the capabilities of the respective devices match capabilities of the mobile telephone 10. For example, if both the mobile telephone 10 and the mobile telephone 10′ have WiFi capability, then the discovery function/circuit 12 will enable the WiFi interface of the mobile telephone 10, thereby enabling the mobile telephone 10 and the mobile telephone 10′ to communicate via WiFi. Should WiFi communications between the respective devices be lost (e.g., they are out of range), the discovery function/circuit 12 then may disable the WiFi interface of the mobile telephone 10.

The same applies with respect to the computer 60. If, via information obtained from the computer 60 over the Bluetooth interface, the discovery function/circuit 12 determines that communications may be established via W-USB, then the discovery function/circuit 12 may enable the W-USB interface of the mobile telephone 10, thereby enabling communications via W-USB between the computer 60 and the mobile telephone 10. FIG. 4B illustrates the communications between the mobile telephone 10 and the mobile telephone 10′, and between the mobile telephone 10 and the computer 60 after the discovery function/circuit 12 has enabled the respective secondary wireless interfaces.

If the WiFi interface of the mobile telephone 10′ and/or W-USB interface of the computer 60 are in the disabled state, the discovery function/circuit 12, in addition to enabling and/or disabling the respective communication interfaces of the mobile telephone 10, also may provide instructions to the mobile telephone 10′ and/or computer 60 to enable their respective communication interfaces. For example, the discovery function/circuit 12, via the Bluetooth interface, may transmit a request to the mobile telephone 10′ and/or computer 60 to enable the WiFi and W-USB interfaces, respectively. The mobile telephone 10′ and the computer 60 then may act on the request and enable the respective interfaces.

Bluetooth devices use an inquiry procedure to discover nearby devices, or to be discovered by devices in their locality. The inquiry procedure is asymmetrical. A Bluetooth device that tries to find other nearby devices is known as an inquiring device and actively sends inquiry requests. Bluetooth devices that are available to be found are known as discoverable devices and listen for these inquiry requests and send responses. The inquiry procedure uses a special physical channel for the inquiry requests and responses.

The inquiry procedure does not make use of any of the architectural layers above the physical channel, although a transient physical link may be considered to be present during the exchange of inquiry and inquiry response information.

When using a primary wireless interface 46 embodied as a Bluetooth interface, discovery of the communication capabilities of other devices may be via SDP (service discovery protocol), which is a discovery feature implemented in the Bluetooth standard. Primary interfaces 46 utilizing protocols other than Bluetooth may use different discovery means.

SDP provides a means for applications to discover what services are available and to determine the characteristics of those services. FIG. 5 illustrates a block diagram of an exemplary SDP, wherein an SDP client and SDP server communicate with one another. It is noted that the SDP server may be a different server from the server 52. In the present example, the mobile telephone 10 may be thought of as the SDP client, while the computer 60 or the mobile telephone 10′ may be thought of as the SDP server.

The SDP client may be running a client application (e.g., an application for enabling or disabling the secondary wireless interface 47), wherein the client application determines when devices (e.g., SDP servers) are within range, and makes specific requests to those devices (e.g., an SDP request). The devices, which may be running server applications (e.g., applications to enable/disable wireless communications based on information provided by the mobile telephone 10), receive and process the SDP request, and respond thereto (e.g., an SDP response).

SDP allows discovery in various forms, including searching and browsing. When browsing, all of the capabilities of the device may be monitored by another device (e.g., the mobile telephone 10 may view all of the capabilities of the computer 60), while searching seeks to identify a specific feature or features of the device (e.g., the mobile telephone 10 seeks to determine whether a specific functionality is available in the computer 60). Preferably, the discovery function/circuit 12 utilized in the mobile telephone 10 implements a search function (as opposed to browse function).

The Bluetooth standard also permits a service search transaction, which allows a client to retrieve the service record handles for particular service records based on the values of attributes contained within those service records. The capability is provided to search only for attributes whose values are Universally Unique Identifiers (UUIDs). Important attributes of services that can be used to search for a service are represented as UUIDs. Service search pattern then can be used to locate the desired service. A service search pattern is a list of UUIDs (service attributes) used to locate matching service records. Such UUIDs also may be indicated or announced via the Bluetooth Extended Inquiry Response.

An Extended Inquiry Response (EIR) can be used to provide miscellaneous information during the inquiry response procedure. Data types are defined for such things as local name and supported services, information that otherwise would have to be obtained during a connection. A device that receives a local name and a list of supported services in an extended inquiry response does not have to connect to do a remote name request and an SDP service search, thereby shortening the time to obtain useful information. It is recommended that a device includes all supported services and a significant minority part of its local name in the extended inquiry response.

The EIR may be used as an alternative way of determining the capabilities of the other devices. For example, the discovery function/circuit 12, using an EIR, may collect device information capabilities as the other devices are initially detected. In this manner, the discovery function/circuit 12 can immediately obtain the information, without performing individual requests for such information.

By defining a Bluetooth SDP UUID and record on each device indicative of whether the device supports a specific wireless technology, the mobile telephone 10 can easily and quickly identify if the other devices have compatible wireless interfaces. For example, and referring back to FIG. 4A, the mobile telephone 10′ and computer 60 each can include a UUID corresponding to their particular wireless interfaces (e.g., the mobile telephone 10′ may have a first UUID (12345) corresponding to WiFi, and the computer 60 may have a second UUID (54321) corresponding to W-USB). The UUID can be stored in non-volatile memory of the respective devices, for example, and can be provided to the mobile telephone 10 via the Bluetooth interface upon receiving an SDP request for such information. If the mobile telephone 10 receives a UUID that corresponds to a particular secondary wireless interface 47 of the mobile telephone 10, then that secondary wireless interface 47 may be enabled and communications can be carried out between the mobile telephone 10 and the other device via the newly enabled interface.

Only one UUID and record need be defined for each wireless technology implemented within the device. For example, if a device has a WiFi interface and a W-USB interface, then two different UUIDs and records can be defined for the device (one for WiFi and one for W-USB). Further, the associated SDP record may contain information to facilitate an easy and quick connection. This can include, for example, information pertaining the addressing, communication data rates, etc.

Additionally, Bluetooth drivers may be made available for older or legacy devices that do not have predefined UUIDs and/or records. These drivers may be stored in a central location (e.g., a server) and accessible via the internet, for example. If a user wishes to enable a legacy device to operate with the discovery function/circuit 12 of the mobile telephone 10, he may connect the legacy device to the server and download the driver corresponding to that particular device. Once transferred, the driver may be executed so as to enable the discovery functionality in the legacy device.

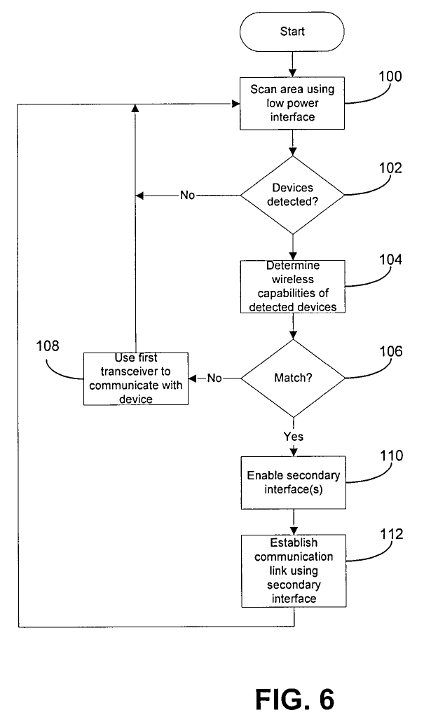

With additional reference to FIG. 6, illustrated are logical operations to implement an exemplary method for enabling and/or disabling communication interfaces of the mobile telephone 10. The exemplary method may be carried out by executing an embodiment of the discovery function 12, for example. Thus, the flow chart of FIG. 6 may be thought of as depicting steps of a method carried out by the mobile telephone 10. Although FIG. 6 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the discovery function 12 may begin at block 100, wherein the discovery function/circuit 12 directs the primary interface 46 to scan the area for other devices. During this scan, the secondary interface(s) 47 may be in a disabled or enabled state. For example, if a communication link is established over a first secondary interface 47, but a communication link is not established over a second secondary interface 47, then the first secondary interface is in an enabled state, while the second secondary interface is in a disabled state. Scanning for other devices over the primary interface 46 may be implemented using conventional methods.

Next at block 102, it is determined if other devices are present that can communicate over the primary interface. If devices are not detected, then the method moves back to block 100 and scanning continues. If one or more devices are detected, then at block 104 the discovery function/circuit 12 determines the wireless capabilities of those devices.

Determination of the wireless capabilities can be accomplished, for example, by sending a request from the detecting device (e.g., the mobile telephone 10) to the detected device (e.g., the mobile telephone 10′ or computer 60) via the primary interface 46. The request may include one or more identifiers that correspond to a particular type of communication protocol or technology (e.g., 12345 corresponds to WiFi, 54321 corresponds to W-USB, etc.). The detected device, via the primary interface 46, then may provide a response to the detecting device indicating whether or not such communication protocols or technologies are available in the device.

Alternatively, the request made by the detecting device may be for a complete list of all communication capabilities of the detected device. The detected device then may provide a response that includes all such capabilities, and the detecting device then can analyze the response to determine if the two devices have other common communication abilities.

At block 106, if the communication capabilities of the two devices do not match (e.g., other than the primary interface, they do not have any other communication interfaces that are compatible with one another), then at block 108 the primary interface 46 is used to exchange data between the devices, and the method moves back to block 100. However, if both devices have other compatible communication capabilities, then at block 110 the secondary interface 47 of the detecting device is enabled. In addition to the secondary interface 47 of the detecting device, the corresponding interface of the detected device also may be enabled (if not presently enabled). Enabling the corresponding interface of the detected device may be based on a command received from the detecting device, or may be automatically performed by the detected device. Once both communication interfaces are enabled, then a communication link may be established over the secondary interface as indicated at block 112, and then the method moves back to block 100.

Accordingly, a device and method for automatically enabling and disabling communication interfaces of an electronic device is provided. Since the enabled/disabled communication interfaces are not actively scanning when not in use, power is conserved, thereby increasing battery life.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A portable electronic device, comprising:
a first wireless interface based on a first wireless technology, said first wireless interface operative to establish a two-way wireless communication link;
a second wireless interface based on a second wireless technology different from the first wireless technology, said second wireless interface operative to establish a two-way wireless communication link; and
a discovery circuit operatively coupled to the first wireless interface and the second wireless interface, said discovery circuit operative to use the first wireless interface to identify wireless capabilities of at least one other device, and to enable or disable the second wireless interface based on the detected capabilities of the at least one other device.

2. The portable electronic device according to claim 1, where in at least one of a standby mode or an active mode, the second wireless interface consumes more power than the first wireless interface.

3. The portable electronic device according to claim 1, wherein the first wireless interface is operative to exchange data at a first data rate, and the second wireless interface is operative to exchange data at a second data rate, wherein the second data rate is greater than the first data rate.

4. The portable electronic device according to claim 1, wherein the first wireless interface is a Bluetooth interface.

5. The portable electronic device according to claim 4, wherein the discovery circuit is operative to use a service discovery protocol (SDP) and universally unique identifier (UUID) to identify the wireless capabilities of the at least one other device.

6. The portable electronic device according to claim 4, wherein the discovery circuit is operative to use an extended inquiry response (EIR) to identify additional information of the at least one other device.

7. The portable electronic device according to claim 1, wherein the second wireless interface is based on at least one of the 802.11x standard or the ECMA-368 standard.

8. The portable electronic device according to claim 1, wherein the discovery circuit is further operative to send a command to the at least one other device via the first interface, said command instructing the at least one other device to enable an interface of the at least one other device corresponding to the second wireless interface.

9. The portable electronic device according to claim 1, wherein the portable electronic device is a mobile telephone.

10. The portable electronic device according to claim 1, wherein the portable electronic device is at least one of a communicator, electronic organizer, personal digital assistant, smart phone, portable communication apparatus, portable gaming device, or portable media devices.

11. A method for conserving power in a portable electronic device, said portable electronic device including a first wireless interface and a second wireless interface different from the first wireless interface, comprising:
using the first wireless interface to establish a communication link with at least one other wireless device;
via the first wireless interface, obtaining from the at least one other wireless device data corresponding to wireless capabilities of the at least one other wireless device; and
enabling or disabling the second wireless interface based on the obtained data.

12. The method according to claim 11, wherein enabling or disabling includes turning a transceiver of the second wireless interface on or off.

13. The method according to claim 11, wherein using the first wireless interface to establish the communication link includes using the first wireless interface to scan for the at least one other wireless device prior to establishing the communication link.

14. The method according to claim 11, wherein using the first wireless interface includes using a Bluetooth wireless interface as the first wireless interface.

15. The method according to claim 14, further comprising using a service discovery protocol (SDP) and universally unique identifier (UUID) to identify the wireless capabilities of the at least one other wireless device.

16. The method according to claim 14, further comprising using an extended inquiry response (EIR) to identify additional information of the at least one other wireless device.

17. The method according to claim 11, wherein obtaining from the at least one other wireless device data corresponding to wireless capabilities of the at least one other wireless device includes at least one of searching or browsing the capabilities of the at least one other wireless device.

18. The method according to claim 11, wherein the second wireless interface is based on at least one of the 802.11x standard or the ECMA-368 standard.

19. The method according to claim 11, further comprising sending a command from the portable electronic device to the at least one other device, said command instructing the at least one other device to enable at least one interface of the device, said at least one interface corresponding to the second wireless interface.

20. A computer program embodied on a machine readable medium for conserving power in a portable electronic device, said portable electronic device including a first wireless interface and a second wireless interface different from the first wireless interface, comprising:
code that uses the first wireless interface to establish a communication link with at least one other wireless device;
code that via the first wireless interface obtains from the at least one other wireless device data corresponding to wireless capabilities of the at least one other wireless device; and
code that enables or disables the second wireless interface based on the obtained data.
